(19) United States
(12) Patent Application Publication
(10) Pub. No.: US 2021/0252897 A1
(43) Pub. Date: Aug. 19, 2021

(54) Peer to Peer Workbook Having Dual-Orientation Accessibility

(71) Applicants: Jenae Heitkamp, Orange, CA (US); Gina Heitkamp, Orange, CA (US)

(72) Inventors: Jenae Heitkamp, Orange, CA (US); Gina Heitkamp, Orange, CA (US)

(21) Appl. No.: 16/991,678

(22) Filed: Aug. 12, 2020

Related U.S. Application Data
(63) Continuation-in-part of application No. 16/790,045, filed on Feb. 13, 2020, now abandoned.

(51) Int. Cl. B42D 1/00

(52) U.S. Cl. CPC B42D 1/009; B42B 5/12

(57) ABSTRACT

The present invention provides a peer to peer workbooks having pages wherein each of at least two opposing (facing) sides of consecutive pages display substantially similar pictorial and textual content, at least one substantially similar question, and at least a designated area to write an answer to the question. Having the question and answering area on opposing sides helps to establish a peer to peer relationship between users, which is thought to encourage discussion, and further facilitate friendship between the users.

This application is a Continuation-In-Part (CIP) of U.S. patent application Ser. No. 16/790,045, filed Feb. 13, 2020. These and all other referenced extrinsic materials are incorporated herein by reference in their entirety.

### FIELD OF THE INVENTION

The field of the invention relates to paper workbooks.

### BACKGROUND

The following description includes information that may be useful in understanding the present invention. It is not an admission that any of the information provided herein is prior art or relevant to the presently claimed invention, or that any publication specifically or implicitly referenced is prior art.

There are many situations in which multiple individuals want to collaborate with respect to the same subject matter to facilitate friendship and collaborative effort. One of the simplest solutions is for the individuals to be in the same room, and to each to have a copy of the same printed materials. One problem, however, is that at any given time, different individuals can be looking at different pages. One could solve that problem by simply projecting an image or text onto a screen that everyone can watch, or using software that allows each individual to simultaneously view a given image on individual display devices. There is even software that allows multiple individuals to simultaneously view, and collaboratively make changes to a given document.

All of those solutions, however, fail to achieve the psychological connection that can happen when two individuals are interacting with the same physical book. However, in that circumstance, the two individuals generally need to be positioned next to each other to simultaneously view a given page. Depending on the individuals and circumstances, such close joint viewing of a given page can be socially problematic, or undesirable for some other reason.

It might be more comfortable for two individuals to sit opposite, or catty corner, from one another when collaborating on a given subject matter. However, with printed subject matter that would mean that one of the collaborating individuals sees the subject matter upside down, or at least at an angle significantly different from a normal viewing angle.

An exemplary book to remedy the defect is shown in the US patent application, 2016/0325576 to Clements. The book can be used for individuals sitting face-to-face, and can share information easily because the same images are flipped over to opposing page sides. As used herein, the term “opposing page sides” means page faces that are juxtaposed when a book is closed. For example, in a typical book, if pages 2 and 3 are opposing, then pages 4 and 5 would be opposing, and pages 6 and 7 would be opposing. But page 3 would not oppose page 4.

One continuing problem, however, is that the Clements book targets individuals having a one-way (one directional) relationship, for example, a teacher to students, a reader to listeners, or an instructor to students. One can tell that Clements is directed to a one-way relationship, because whereas the Clements' book includes guidance (statements, questions, drawings, and images), only the side available to one of the users has a space to write answers or other responses.

Accordingly, Clements did not contemplate, and is not physically adapted to, facilitating a peer to peer (two-way) relationship, such as between friends communicating/discussing each other to facilitate friendship, where the sides presented to both users have guidance materials and corresponding spaces to write answers or other responses.

What is needed is a workbook that allows individuals to work on basically the same subject matter, by displaying to different users substantially duplicate guidance materials, and corresponding spaces to write answers or other responses.

### SUMMARY OF THE INVENTION

The inventive subject matter provides a dual-orientation accessible book for facilitating communication among users of the workbook, having opposing page sides that display to different users (a) substantially duplicate guidance materials, and (b) corresponding spaces to write answers or other responses. In preferred embodiments, such books employ connectors that allow opposing pages to be displayed between 30 degrees and 180 degrees apart from one another.

As used herein, the terms “substantially similar pictorial and textual content” means content that would be recognized by an ordinary observer as being duplicative, other than with respect to size, coloration, or formatting.

For example, two opposing page sides would be deemed to have substantially similar pictorial content if one side has an image of a bird in flight, and the other side has the bird image in a different size or color, or in black and white. On the other hand, if the other side shows the bird standing on a branch, the two side would not be deemed to have substantially similar pictorial content.

Similarly, two opposing page sides would be deemed to have substantially similar textual content if the two sides include the same text, but formatted with different fonts, font sizes, font colors, italic, bold, and/or letter spacing, etc.

As used herein, the terms “substantially similar” with respect to content on opposing pages, whether question, pictorial content, or other content, means that an ordinary observer would recognize the meaning of such content as being duplicative. As used herein, substantially similar content is agnostic with respect to size, coloration, or formatting. For example, opposing page sides would be deemed to have a substantially similar question if one side has the text of a question in highlight, and the other side has the same text, but in a different size or color, or without highlighting.

In preferred embodiments, each of the opposing page sides includes at least a substantially similar question related to displayed pictorial and/or textual content, and a designated area to write an answer to the question. In some embodiments, each side has at least two questions and corresponding answer areas.

One huge advantage of having a peer-to-peer workbook, with answer spaces on opposing pages, is that first and second users can face each other while filling in the answer spaces, and then turn the book around to see each other's answers. One can't do that with a Clements type of workbook because only one of the users has answer spaces for any given set of opposing/duplicate pages.

In some embodiments, the substantially similar pictorial and textual content covers at least 50% of the visual areas of at least one set of opposing page sides. In more preferred embodiments, the substantially similar pictorial and textual content covers at least 75% of the visual areas on at least one set of opposing page sides.

In some embodiments, the substantially similar pictorial and textual content includes a question and a designated area to write an answer to the question. Also in preferred embodiments, the substantially similar pictorial and textual content includes an image, and the question relates to an aspect of the image.

All suitable connectors are contemplated to couple the various sheets, including for example, rings, cords, spirals, and perfect binding. The binding can be loose and/or elastic, such that opposing stacks of pages can be separated by several centimeters. Where opposing stacks of pages are to be angled other than approximately 180 degrees away from each other, a single ring or cord could be advantageously placed near a corner of the book.

It is contemplated that such books could have five, ten, twenty, fifty or more sets of opposing page sides with substantially similar pictorial and textual content. Contemplated books can have any reasonable dimensions, but preferably having length of 10-30 cm, width of 20-30 cm, and thickness of 1-5 cm.

Angles between opposing pages sides need not be the same as angles between substantially similar pictorial and textual content on such page sides. For example, a binding might restrict opposing page sides to be 180 opposite to one another, but the pictorial and textual content on one or both of the pages could be skewed, rather than lining up normally on the page. Similarly, a binding might restrict allow opposing page sides to be 175 degrees opposite to one another, but the pictorial and textual content on one or both of the pages could be collectively skewed by 15 degrees, such that persons viewing the book completely opposite to one another might still view the substantially similar pictorial and textual content normally on the opposing page sides.

In some embodiments, dual-orientation accessible books could have a stand that props up the book, with the binding forming an apex of a triangular configuration.

Each of sheets can be printed papers, printed plastics, printed metal, or combination thereof.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A-1F are multiple perspective views of pages in a dual-orientation accessible book. The book has a perfect binding.

FIG. 2A is a plan view of opposing page sides in a book having set of substantially similar pictorial and textual content that includes an image, a question relating to the image, and an answer space. The book has a spiral binding. The substantially similar pictorial and textual content should be interpreted as covering at least 50% of each of the visually accessible areas on the opposing page sides. The book has an elastic string binding.

FIG. 2B is a plan view of opposing page sides similar to that of FIG. 2A, except that one of the page sides has a pre-printed answer in place of the answer space.

FIG. 3 is a plan view of opposing page sides in which the substantially similar pictorial and textual content is skewed, approximately 170 degrees from each other.

FIG. 4 is a plan view of a book having opposing page sides with substantially similar pictorial and textual content, having a corner ring binding, and pages stacks oriented approximately 35 degrees from each other.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The recitation of ranges of values herein is merely intended to serve as a shorthand method of referring individually to each separate value falling within the range. Unless otherwise indicated herein, each individual value is incorporated into the specification as if it were individually recited herein.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

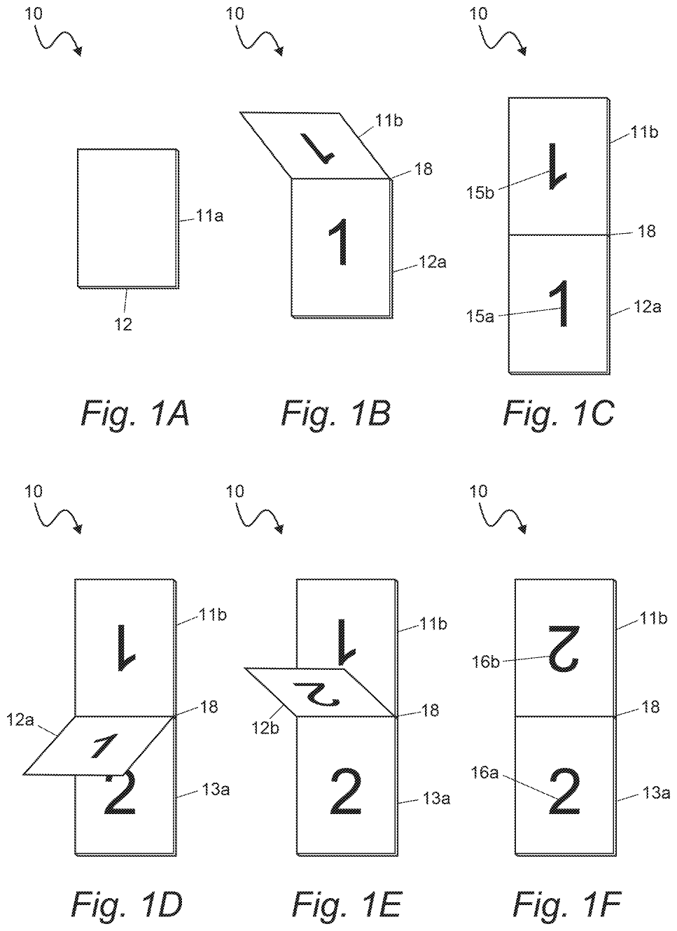

FIGS. 1A-1F depict sequential views in opening, and then flipping over a page, of a dual-orientation accessible book (10). As shown in FIG. 1A-1C, the book has at least two sheets, and a sheet has two sides, a side A (11a) and a side B (11b). The first sheet (11) is coupled to the second sheet (12) by a connector (18), which in this example is a perfect style book binding. When the first sheet (11) is flipped over the connector, the book concurrently reveals the B side of the first sheet (11b) and the A side of the second sheet (12a). The B side of the first sheet (11b) displays substantially similar pictorial and textual content (15a/15b) to the A side of the second sheet (12a). In this example, page sides (11b) and (12a) are opposing sides.

The book can further comprise a third (13) sheet, a fourth (14) sheet, and so on, all coupled through the connector (18). When the second sheet (12) is flipped over the connector (18), the book (10) concurrently reveals the B side of the second sheet (12b) and the A side of the third sheet (13a). The B side of the second sheet (12b) and the A side of the third sheet (13a) display a second set of substantially similar pictorial and textual content (16a/16b). In general, instances of substantially similar pictorial and textual content can be printed or otherwise displayed on opposing (i.e., facing) sides of any two consecutive sheets.

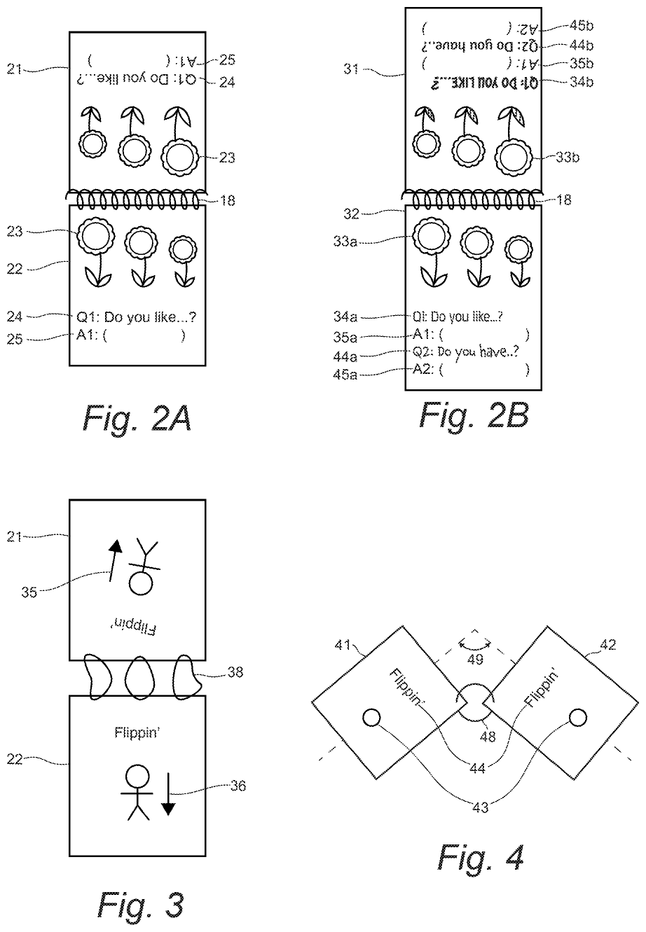

In some embodiments, at least 50% of the entire visible area of opposing sides of consecutive sheets is used for the substantially similar pictorial and textual content. As shown in FIGS. 2A and 2B, at least 75% of the entire visible area of opposing sides of consecutive sheets can advantageously be used for the substantially similar pictorial and textual content. substantially similar pictorial and textual content can comprise any one or more pictures, drawings, graphs, tables, questions or other text, designated areas to write answers, pre-printed answers, etc.

Examples of substantially similar pictorial and textual context are shown in FIGS. 2A and 2B. In FIG. 2A, an image (23), a question (24), and an area (25) designated to write an answer to the question are displayed on the side of one sheet (21), and the opposing side of sheet (22) has a substantially similar image (23), substantially similar question (24), and substantially similar area (25) designated to write an answer to the question.

FIG. 2B is similar to FIG. 2A, except that each of the opposing sides have an additional question and an additional area to write an answer to the question. In FIG. 2A, an image (33a), two questions (34a, 44a), and two areas (35a, 45a) designated to write an answer to the question are displayed on the side of one sheet (31), and the opposing side of sheet (32) has a substantially similar image (33b), questions (34b, 44b) which are substantially similar to questions (34a, 44a), respectively), and response areas (35b, 45b) which are substantially similar to response areas (35a, 45a), respectively.

FIG. 3 is a plan view of opposing page sides in which the respective substantially similar pictorial and textual content is skewed. In this case the substantially similar pictorial and textual content of side (21) is only approximately 170 degrees off from the substantially similar pictorial and textual content of side (22), rather than the expected 180 degrees. Likely skewing of this sort can be advantageous between 170° and 180°, and between 150° and 170° so that two persons can conveniently work on a book opened 180 degrees without being directly opposite each other.

The connector can be a ring (48), spiral binding (28), a cord (38), a string (38), a perfect style book binding (18) or combination thereof. The connector can be elastic (38) and flexible (38) like a rubber band.

The sheets can be a printed paper, a printed plastic, printed metal, or combination thereof.

FIG. 4 depicts a plan view of a book having opposing page sides (41/42) with substantially similar pictorial (43) and textual (44) content, having a corner ring binding (48), and pages stacks oriented approximately 100 degrees (49) from each other. Such a book can be conveniently used by individuals positioned directly opposite to one another, as well as individuals facing one another at angles between 30 degrees and 180 degrees.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A peer to peer flipping workbook configured to be operated by first and second users, the workbook comprising:
at least a first sheet having A and B sides;
at least a second sheet having A and B sides;
a connector that physically couples the first sheet and second sheets;
wherein each of the B side of the first sheet and the A side of the second sheet is configured to facilitate communication between the first and second users by inclusion of (1) a first set of substantially similar pictorial and textual content, (2) a first substantially similar question related to the pictorial and textual content, and (3) a first designated answer space positioned over a user writable surface; and
wherein the at least first and second sheets comprising a material such that:
the workbook can be stood in a triangular position with the connector positioned between the first and second sheets; and
the workbook is configured such that when the first sheet is flipped over the connector, the first and second users can face each other while the first user is writing in the answer space of the B side of the first sheet, and the second user is writing in the answer space of the A side of the second sheet, and then turn the workbook around to see each other's answers.

2. The peer to peer flipping workbook of claim 1, wherein each of the B side of the first sheet and the A side of the second sheet has a visually accessible area, and wherein the substantially similar pictorial and textual content covers at least 35% of each of the visually accessible areas on the B side of the first sheet and the A side of the second sheet.

3. The peer to peer flipping workbook of claim 1, wherein each of the B side of the first sheet and the A side of the second sheet has a visually accessible area, and wherein the substantially similar pictorial and textual content covers at least 50% of each of the visually accessible areas on the B side of the first sheet and the A side of the second sheet.

4. The peer to peer flipping workbook of claim 1, wherein the B side of the first sheet and the A side of the second sheet each additionally displays a second substantially similar question related to the pictorial and textual content, and a second designated answer space to write an answer to the question.

5-8. (canceled)

9. The peer to peer flipping workbook of claim 1, further comprising a third sheet having A and B sides, the third sheet coupled to the first and second sheets such that when the second sheet is flipped over the connector, the B side of the second sheet and the A side of the third sheet display a second set of substantially similar pictorial and textual content, and each side additionally displays a second substantially similar question related to the second pictorial and textual content, and a second designated answer space to write an answer to the second question.

10. The peer to peer flipping workbook of claim 1, wherein the connector comprises a ring or spiral binding.

11. The peer to peer flipping workbook of claim 1, wherein the connector comprises a cord.

12. The peer to peer flipping workbook of claim 1, wherein the connector comprises a string.

13. (canceled)

14. The peer to peer flipping workbook of claim 1, wherein the connector is elastically configured to allow the B side of the first sheet to be oriented between 30° and 180° with respect to the A side of the second sheet, when the workbook is open, and lying flat on a table.

15. The peer to peer flipping workbook of claim 1, wherein the material comprising each of the first and second sheets includes a plastic.

16. The peer to peer flipping workbook of claim 1, wherein the material comprising each of the first and second sheets includes a metal.
